(19) United States
(12) Patent Application Publication
(10) Pub. No.: US 2010/0212383 A1
(43) Pub. Date: Aug. 26, 2010

(54) Bump-Resistant Pin Tumbler Lock

(76) Inventor: Craig Robert Stuart, Waipawa (NZ)

Correspondence Address: Craig Stuart, 5 Ruantaniwha St., Waipawa, 4210, NZ

(21) Appl. No.: 12/517,090

(22) PCT Filed: Oct. 23, 2007
(86) PCT No.: PCT/NZ2007/000318

§ 371 Date: Jun. 1, 2009

(30) Foreign Application Priority Data
Dec. 5, 2006 (NZ) 551796

(51) Int. Cl. E05B 27/08; B23P 11/00

(52) U.S. Cl. 70/493; 29/428

(57) ABSTRACT

A bump resistant pin-tumbler lock having a housing; a plug rotatably mounted within the housing and having a keyway; and a shear line defined between the interface between the plug and housing. The plug has one or more pin chambers extending from and orthogonally to the shear line and the keyway, wherein each pin chamber is capable of housing a bottom pin and is aligned with a corresponding driver chamber when the plug is in a locked position. Each driver chamber extends into the housing from and orthogonally to the shear line, includes a biasing means and is capable of housing one or more top pins. The plug further includes a bottom pin retaining means extending into one of the pin chambers so as to selectively retain a predetermined bottom pin in its respective pin chamber and prevent the predetermined bottom pin from fully extending into the pin chambers, such that, in use, kinetic energy cannot be transferred to the predetermined bottom pin from a bump member.

The present invention relates generally to bump-resistant pin-tumbler locks. More particularly, this invention is directed to enhancing the security afforded by pin-tumbler locks.

### BACKGROUND

The majority of locks currently in use around the world are ‘pin-tumbler’ locks and their design has changed little since their invention by Linus Yale in 1861. These locks are generally comprised of a lock plug which is rotatable inside a cylinder on insertion and rotation of the correct key in a keyway provided in the plug. The cylinder generally includes an in-line set of 5 or 6 pin chambers, each chamber containing a spring-loaded top pin adjacent to a bottom pin of varying length. The lock plug cannot be rotated within the lock housing without a key because the pins traverse the seam or shear line between the plug and housing, since each spring urges a corresponding pin to a position of maximum extension within the plug such that at least one pin is partly inside one of the pin chambers and partly inside a corresponding aperture in the plug; wherein the chamber and aperture are axially aligned when the plug is in its normal, resting position. Once the correct key has been inserted into the keyway, the joins between each of the top and bottom pins are lined up flush with the shear line between the plug and housing, thereby allowing the plug to turn upon application of torque to the key whilst held in the keyway.

A ‘bump’ key is a key which is designed to engage all bottom pins in a pin-tumbler lock at the position of maximum extension. When kinetic energy is applied to the head of the key, this energy is transferred from the key through the bottom pins to the top pins of the lock. By applying kinetic energy to a ‘bump’ key to transfer sufficient kinetic energy to compress the springs in each of the chambers to a position wherein the bottom pins in every chamber of the lock are separated from the top pins or are flush or align with the shear line can enable a person to open a lock by applying torque to the head of a ‘bump’ key with good timing. A ‘bump’ key can be readily made, can be used with a low level of skill and work well on paracentric keyways. It is recognised that ‘bump’ keys work on much the same principle as a pick gun. However, pick guns are not readily available to unauthorised individuals, require greater user skill and do not work well on paracentric keyways.

‘Bump’ keys may be used to ‘bump’ any number of standard pin-tumbler locks which are of the same key profile. In addition, when compared to traditional methods of lock picking, ‘bump’ keys leave little or no evidence that the lock has been opened using a method other than inserting the correct key. For example, if a bump key has been used to break into a house, there is often no sign of forced entry and an insurance company may be wary of paying insurance for any subsequent claim.

The availability of information, particularly on the Internet, on ‘bumping’ has exacerbated the situation making it a major threat to locks and security as a whole worldwide.

Several bump-resistant systems have been developed in order to combat this ‘bump’ technique. Firstly, keys with dimple formation operating side bars have been devised, but the corresponding locks are still capable of being ‘bumped’ through the transfer of kinetic energy by persons having a key with the same set of side cuts. Pin-tumbler locks which will only turn when a key containing an electronic chip is inserted into the lock have also been devised. These locks have the disadvantage of being expensive, require complete replacement of an existing lock and are often only used for external locks to commercial buildings and the like. Internal and domestic locks therefore remain susceptible to ‘bumping’.

Another technique described in US 2006/0048554 uses a set of pins in which the combined length of all pins in a single pin chamber is longer than the length of the pin chamber within the cylinder. Therefore, when ‘bumped’ and all the pins in the lock are forced laterally from inside the plug the one or more pins in the pin chamber may continue to prevent the lock from turning. While this method is not more expensive in terms of lock manufacture, it is not possible to retrofit an existing lock to this mechanism.

Master Lock Company LLC have developed bump resistant locks under the brand name BumpStop. A wider top pin is used with a short tip that enters the plug chamber and creates a gap between the top pin and a short bottom pin. It cannot be retrofitted to existing locks or requires replacement of the cylinder housing. If all chambers were drilled to use the wider top pins then the lock would be easier to pick because it would not readily bind a bottom pin that was over lifted to a positive locking position. Also, if the same chamber is always used, then the number of combinations available is reduced and a modified bump key could be made to open all the locks that used the same chamber for their short bottom pin modified top pin chamber.

It is to be appreciated that the term ‘bump-resistant’ as used throughout the specification is to be understood as including a lock that is resistant to or less prone to being opened by a technique that requires the transfer of kinetic energy to all pins of a lock such as through use of a ‘bump’ member including but not limited to a pick gun or a ‘bump’ key.

### OBJECT

It is an object of the invention to provide a simple, durable, inexpensive bump-resistant pin-tumbler lock that is substantially compatible with existing cylinders and keyways.

Alternatively, it is an object of the invention to provide a bump-resistant pin-tumbler lock, or a plug for use in a bump-resistant pin-tumbler lock or a method of manufacturing or modifying one or more existing pin-tumbler locks to become bump-resistant or more bump resistant.

Alternatively, it is an object to at least provide the public with a useful choice.

### SUMMARY OF INVENTION

Accordingly in the first aspect the present invention provides a bump resistant pin-tumbler lock including:

A bump resistant pin-tumbler lock including:
a housing;
a plug rotatably mounted within the housing and having a keyway extending substantially along the longitudinal axis thereof, the keyway being shaped and dimensioned to receive a key for the lock;
a shear line defined between the interface of the plug and housing;
wherein the plug has one or more pin chambers extending substantially from and substantially orthogonally to the shear line and the keyway, wherein each pin chamber is capable of housing a bottom pin, and wherein each pin chamber is aligned with a corresponding driver chamber when the plug is in a locked position;
wherein each driver chamber extends into the housing substantially from and substantially orthogonally to the shear line and wherein each driver chamber further includes a biasing means and is capable of housing one or more top pins;
wherein the plug further includes a bottom pin retaining means extending into one of the pin chambers so as to selectively retain a predetermined bottom pin in its respective pin chamber and prevent the predetermined bottom pin from fully extending into its full depth resting position such that, in use, kinetic energy cannot be transferred to the predetermined bottom pin from a bump member that is cut to the full depth in all positions; and
wherein said pin retaining means is shaped and dimensioned so that it does not interfere with the actuation of the lock by the key by extending into the keyway.

A plurality of pin retaining means may be provided for each of a corresponding plurality of bottom pins. Alternatively, the pin retaining means may be configured to selectively retain a plurality of the bottom pins.

Preferably the plug extends substantially along the length of the housing.

Preferably the pin-tumbler lock is an in-line pin tumbler lock.

Preferably the pin retaining means is adapted and dimensioned so that the predetermined bottom pin rests on the pin retaining means.

Preferably the pin retaining means is positioned in one or more pin retaining means chambers which have been, preferably, drilled in the plug. In one embodiment the one or more pin retaining means chambers have been drilled in the plug after manufacture and installation of the lock.

Preferably the pin retaining means extends from the external surface of the plug adjacent the shear line into the keyway.

Preferably the pin retaining means chamber extends into the pin chamber substantially orthogonally thereto.

Preferably the pin retaining means has a length of about 4 mm to about 6 mm.

Preferably at least a portion of the pin retaining means is tapered. More preferably the diameter of the first end of the pin retaining means that extends into the pin chamber is equal to or less than about 1.5 mm and the diameter of the second end of the pin retaining means proximate the shear line is less than about 3 mm. Most preferably the second end of the pin retaining means does not extend beyond the shear line and does not contact the housing so that movement is unaffected when the plug is rotated.

Preferably the pin retaining means is made of brass, plastic, steel or hardened steel. Most preferably the retaining means is made of brass.

Preferably the pin retaining means is removable from its pin retaining means chamber.

Preferably the one or more pin retaining means are inserted into one or more pin retaining means chambers during manufacture.

According to particular embodiments having a plurality of pins, pin retaining means chambers may be provided for all or at least more than one of the pins. All or a subset of the pin retaining means chambers may be provided with pin retaining means.

In a second aspect of the present invention there is provided a plug for use in a bump-resistant pin tumbler lock as defined above, the plug including:
a keyway extending substantially along the longitudinal axis of the plug, the keyway being shaped and dimensioned to receive a key for the lock;
one or more pin chambers extending substantially from the keyway, wherein each pin chamber is capable of housing a bottom pin;
at least one bottom pin retaining means chamber extending substantially orthogonal to a respective one of the at least one pin chambers, wherein said at least one bottom pin retaining means chamber is configured to receive a bottom pin retaining means in use so as to selectively retain a bottom pin in its respective pin chamber and prevent the bottom pin from fully extending into the bottom pin chamber, such that in use, kinetic energy cannot be transferred to the retained bottom pin from a bump member; and
wherein said pin retaining means is shaped and dimensioned so that it does not interfere with the actuation of the lock by the key.

Preferably the plug is configured for use in an in-line pin tumbler lock.

Preferably the pin retaining means chamber is adapted and dimensioned so that the bottom pin rests on the pin retaining means in use.

Preferably the pin retaining means chambers are formed by drilling into the plug. In one embodiment the one or more pin retaining means chambers are drilled in the plug after manufacture and installation of the lock.

Preferably the one or more pin retaining means are inserted into one or more the pin retaining means chambers during manufacture.

In a third aspect the present invention provides a method of manufacturing one or more bump-resistant locks or one or more plugs as defined above, the method including the step of forming at least one pin retaining means chamber in the plug of a pin tumbler lock, wherein in use the at least one pin retaining means chamber is capable of housing a pin retaining means.

Preferably the method further includes, the step of positioning a pin retaining means in the or in at least one of the pin retaining means chamber(s).

In a fourth aspect the present invention provides a method of retrofitting a pin-tumbler lock, the method including the step of forming at least one pin retaining means chamber in the plug of a pin tumbler lock, wherein in use the at least one pin retaining means chamber is capable of housing a pin retaining means so as to provide a bump resistant pin tumbler lock as defined above.

Preferably the method further includes the step of positioning at least one pin retaining means in the or in at least one of the pin retaining means chamber(s).

Preferably the at least one pin retaining means chamber is drilled and the at least one pin retaining means is tapped into the pin retaining means chamber.

Further aspects of the present invention, which should be considered in all its novel aspects, will become apparent to those skilled in the art from the following description, which provides at least one example of a practical application of the invention.

### BRIEF DESCRIPTION OF THE DRAWINGS

At least one embodiment of the invention will now be described, by way of example only, with reference to the accompanying drawings in which:

FIG. 1 shows an exploded view of the components of an embodiment of a bump resistant pin tumbler lock and a corresponding key;

FIGS. 2a and 2b show cross sectional views of the lock shown in FIG. 1 in different states;

FIGS. 3a and 3b show alternative cross sectional views of the lock shown in FIG. 1 with key inserted and removed from the keyway, respectively.

FIG. 4 shows alternative embodiments of a pin retaining means.

FIGS. 5a and 5b show an alternative embodiment of a pin retaining means and its preferred placement within a lock.

### DETAILED DESCRIPTION

In broad terms, the invention provides and makes use of one or more obstructions (which are preferably removable and/or capable of being positioned in different configurations) which limit the travel of one or more corresponding bottom pins of a pin-tumbler lock in its chamber so that the one or more bottom pins will not sit on a bump key. This improves resistance to bumping because locks according to the invention have different possible combinations of resting positions of the bottom pins, thus bump keys appropriate therefor must be correspondingly configured. This makes bump keys largely impractical or at least raises the skill level required in the use thereof.

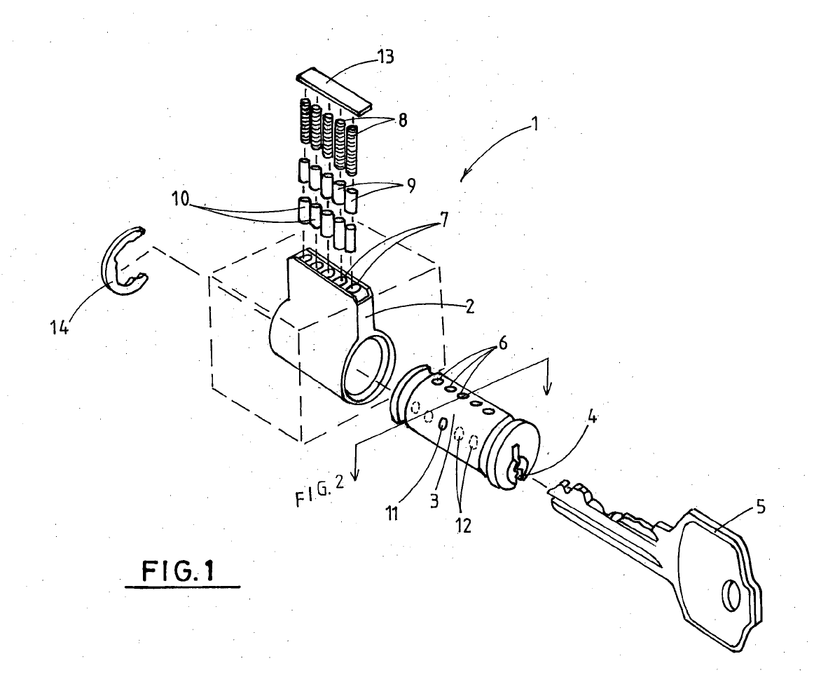

With reference to FIG. 1 the present invention provides a bump resistant pin-tumbler lock (1) including a housing (2). The housing houses a substantially cylindrical plug (3). The plug (3) extends substantially along the length of the housing and the plug is rotatable within the housing. The plug has a keyway (4) dimensioned to receive a key (5). The keyway extends substantially along the longitudinal axis of the plug, and includes one or more generally cylindrical pin chambers (6). In this embodiment there are 5 pin chambers, however, this invention is applicable to a pin tumbler lock having any number of pin chambers. Each pin chamber (6) can be aligned with a corresponding driver chamber (7) when the plug is in its rest position. The driver chambers are positioned in the housing. Each pin chamber and driver chamber together house a biasing means (8), one or more top pins (9), and one or more bottom pins (10). A pin retaining means (11) is positioned in a pin retaining means chamber (12). In FIG. 1 there are five pin retaining means chambers illustrated, however it is to be appreciated that only one pin retaining means chamber is required. In this example, the biasing means (8) and top and bottom pins (9) and (10) are retained in their chambers by a slide cap (13). The plug is retained in the housing by a keeping means (14).

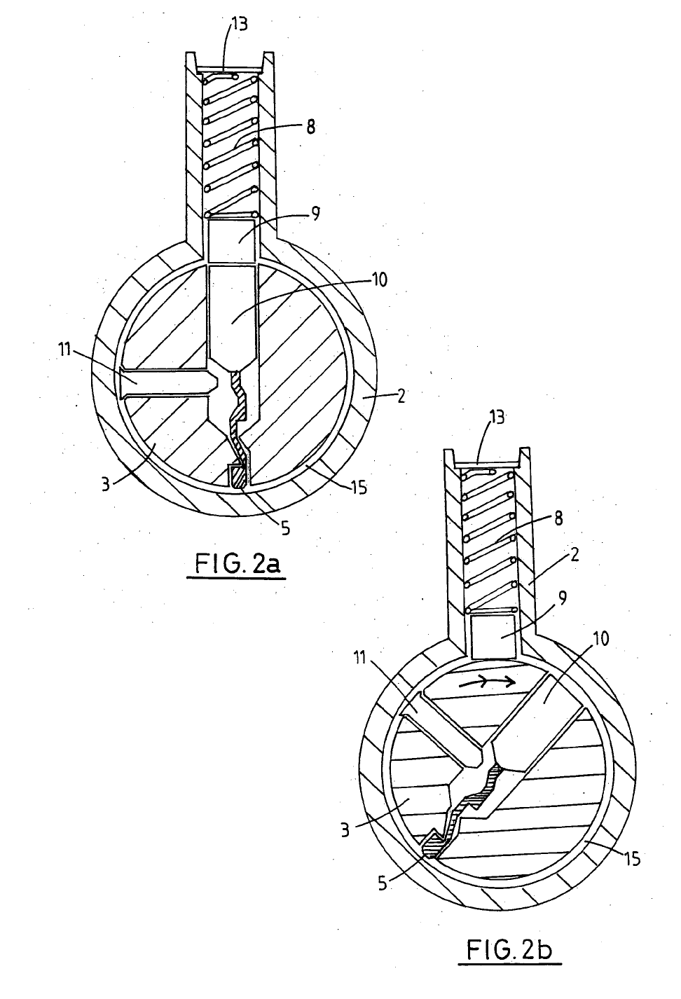

With reference to FIG. 2a the pin retaining means (11) intrudes towards the keyway (4) of the lock and retains a bottom pin (10). The retaining means prevents the full depression of the bottom pin into the pin chamber by not allowing the bottom pin to pass by the pin retaining means. The lock in FIG. 2a is in a “locked position”, meaning that the plug (3) cannot be rotated relative to the housing (4) because the top pin (9) interrupts the circumferential shear line (15) that extends between the inner wall of the housing and the outer circumferential wall of the plug. When the shear line is interrupted by a top pin the lock is in the “locked position” because the plug cannot be rotated relative to the housing.

In contrast, with reference to FIG. 2b the key (5) is shown in position in the keyway and the lock is in an “open position”. The key exerts pressure against the biasing means (8), this pressure depresses the biasing means and pushes the bottom pin (10) away from the pin retaining means (11) until the interface of the top pin (9) and the bottom pin (10) aligns with the circumferential shear line (15) between the plug (3) and housing (4). This means that the plug can be rotated relative to the housing allowing the lock to move into an “open position” as shown in FIG. 2b.

It is to be appreciated that the plug illustrated in FIGS. 2a and 2b could in itself be a stand-alone commercial unit that is manufactured and sold independently of a lock housing.

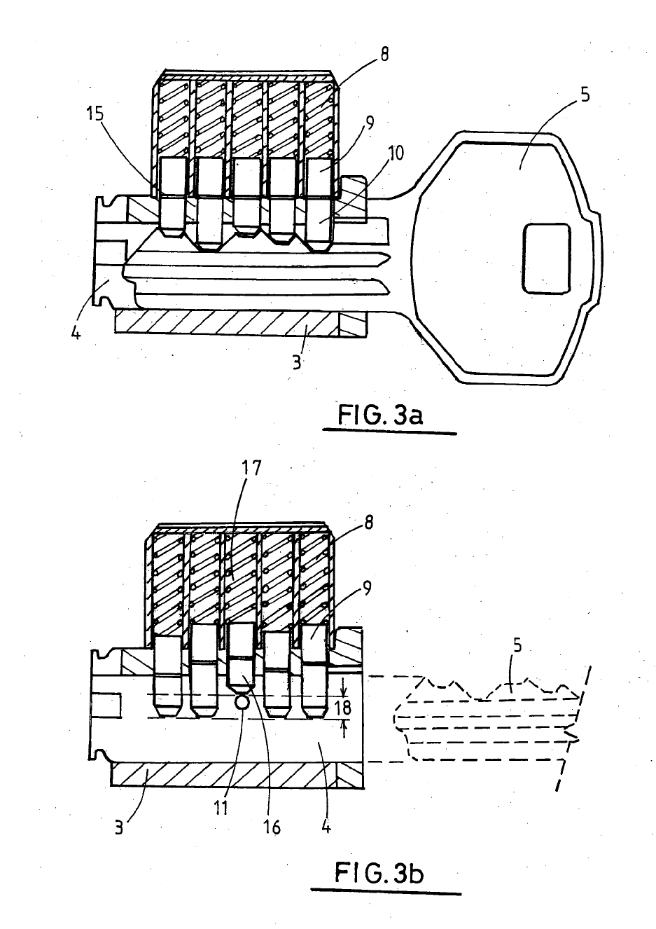

With reference to FIG. 3a a cross sectional view along the length of the keyway, when the key (5) is in position is shown. The relationship between the top pins (9) and bottom pins (10) across all the pin chambers is illustrated. The alignment of all the bottom pins by the key with the circumferential shear line (15) is shown, meaning that the lock is in an “open position” and the plug (3) can be rotated relative to the housing (4).

In contrast with reference to FIG. 3b the keyway (4) is shown with the key (5) removed. The arrangement of the top pins (9) and bottom pins (10) across the chambers is shown. Also shown is the pin retaining means (11) that selectively prevents one of the bottom pins (16) from being depressed fully into the pin chamber through its biasing means (17). This retention of bottom pin (16) provides a gap (18) between the bottom pin (16) and its fully depressed neighbouring bottom pins (10). This gap that is created means that any bump key, which is inserted into the lock and “bumped” cannot impart kinetic energy to bottom pin (16) because of the gap created through the retention of the bottom pin (16). This means that bottom pin (16) cannot be bumped to align with the circumferential shear line (15) which prevents the lock from being actuated into an “open position” with a “bump” key, thereby providing a further level of security to a pin tumbler lock. It is to be appreciated that any arrangement of pin retaining means is envisaged. For example each of the bottom pins may be retained by a corresponding pin retaining means. Alternatively it is envisaged that a single pin retaining means may be positioned intermediate any two bottom pins such that two bottom pins are retained. A large number of possible combinations or permutations of arrangements are envisaged and this in itself also adds a further level of security.

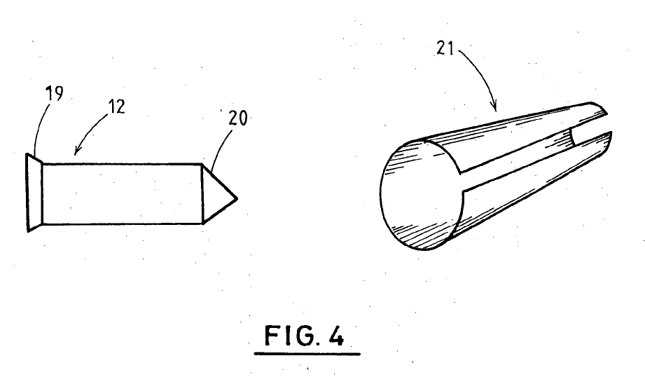

All the features of the pin tumbler lock are conventional except for the pin retaining means (11) and the pin retaining means chamber(s) (12) as shown in FIG. 1. As illustrated in FIG. 4, the pin retaining means is preferably shaped like a pin or a nail. It is preferred that the head (19) of the pin retaining means is flared slightly to prevent the pin retaining means from moving into the keyway. The diameter of the head of the pin retaining means is preferably less than the diameter of the bottom pins. It is also preferred that the corresponding pin retaining means chamber is formed to provide a substantially countersunk feature to receive the head (19) of the pin and to ensure that the pin retaining means does not extend too far beyond the external surface of the plug. This is to ensure that there is no abrasion between the pin retaining means and the housing when the plug is rotated within the housing. The shape of the pin retaining means is such that the diameter of the tapered end (20) of the pin that extends towards the keyway is approximately 1.5 mm. It has also been recognised that a 240 thou (approximately 6 mm) bottom pin (also known as a size 6 bottom pin) could be used as a suitable pin retaining means. However, it is recognised that when the pin retaining means chamber (12) is drilled for a 6 mm bottom pin or the like the depth of the chamber would need to be accurate to leave a shoulder in the chamber to stop the pin from moving into the keyway and thereby blocking the keyway. A tapered nail or pin with a flared head end would be more suitable for the modification of locks on-site because the chamber (12) drilled for the pin retaining means can go right through to the keyway because the flared head acts as a stop or limiter. It is also to be appreciated that a tapered roll pin (21) made from spring steel could also be used as a pin retaining means.

In practice, each pin chamber (6) that is retained in a master keyed system would have a limited maximum pin stack height. Thus it is preferable that all chambers (6) in a plug (3) would be retainable by way of a pin retaining means to provide a large number of combinations for setting a particular lock. The corresponding pin retaining means chambers that are not used for retaining a pin in order to allow that chamber to have full movement could have blanking pins inserted into them to fill the retaining means chamber if necessary because of the preferred use of pin retaining means that are the same diameter as the bottom pins. Changing a combination on a master keyed system to a completely new combination for a new set of keys could then be achieved simply by swapping the positions of the blanking pins and the retaining pins.

It is to be appreciated that a ‘bump’ key could still be made for an individual master keyed system by cutting the ‘bump’ key such that the key corresponds to a depth with the particular chamber and position at which the pin retaining means sits. However where the pins in more than one chamber have been retained by a pin retaining member then a ‘bump’ key that corresponds in depth with only one of the pins retained in one of the chambers would not work. This makes the manufacture of the ‘bump’ key much more difficult because the key has to be cut to specific depths accurately and they have to align with the correct chamber accurately. Also where no prior knowledge exists of which chambers are restricted in their movement an unauthorised person would have to make and try many different combinations of ‘bump’ keys to successfully ‘bump’ and open a lock. For a six chamber keyway where at least one retaining means were at one depth an unauthorised person would have to make 58 bump keys to open all possible combinations of locks manufactured that way. Security is vastly increased because pick guns will not be able to reliably open the locks and making ‘bump’ keys will require much more skill and many more blanks (getting one key of a particular profile is relatively easy, however, getting 58 is much more difficult). Also trying 58 bump keys requires patience or the additional ability to scope or feel the lock to determine which ‘bump’ key to use. Thus this invention does not stop the production of ‘bump’ keys but rather makes them so much more difficult to make and use that they will not be the opportunistic problem they are now for low security situations.

Other high security systems using rotating disk tumblers or side bar technologies require the replacement of the plug and the chamber and the keys and consequently cost more. In contrast the present invention provides an enhanced security system that can be achieved by using the existing keys, the existing chambers while only replacing or modifying the plug and adding some extra pins for the retaining pins.

In terms of manufacturing a pin tumbler lock to include one or more pin retaining means chambers it is envisaged that the pin retaining means chambers would be formed at much the same time that the pin chambers are formed. For example the plug could be rotated approximately 90 degrees about the axis of the plug after formation of the pin chambers and then the one or more pin retaining means chambers formed through a single drilling action. In terms of retrofitting an existing plug, it is envisaged that a jig and plug mounting device could be prepared for use by a locksmith to enable the plug to be drilled to provide one or more plug retaining means chamber.

Where a bottom pin (or other pin not having ahead) is used as a pin retaining means, the pin retaining means chambers of the plug are drilled by the manufacturer or installer so that the tip of the drill should only just enter the vertical pin chamber, this is so that shoulders at one keyway end of the pin retaining means chamber are defined which limit the movement of the pin retaining means into the keyway, while still allowing the tip of the pin retaining means to limit the movement of the pin in the pin chamber. Also if a blank, such as a square pin like a conventional top pin is put in the pin retaining means chamber it will stop against the shoulders of the pin retaining means chamber and not interfere with the movement of the bottom pins in the pin chambers. Thus bottom pin chambers which are to have the movement of their respective bottom pins limited in order to thwart ‘bump’ keys will have a pin similar to a bottom pin in the respective pin retaining means chambers and bottom pin chambers which are to have normal movement will have square ended pins in their respective pin retaining means chambers. From a manufacturing point of view this is ideal because a manufacturer can gang drill a series of pin retaining means chambers using the same drills that make the bottom pin chambers. The pin retaining means chambers can then be filled to the shear line with either a top pin (square ended) of the right dimension to completely fill the pin retaining means chamber but not limit the movement of the corresponding bottom pin in its respective pin chamber, or the pin retaining member being either a selected bottom pin of the correct dimensions or a tapered pin of the right length to preferably completely fill the pin retaining means chamber to the shearline which will have its tip protruding into the pin and block the pin stack from resting on a bump key or pick-gun needle.

It is an advantage of particular embodiments of the present invention that if a plug was manufactured as described immediately above, the manufacturer or a locksmith would not even have to get pin retaining means made of new dimensions because a combination of existing bottom pins, top pins and master chips that are readily available to a locksmith and manufacturer could be used to fill the pin retaining means chambers. The repinning or master keying in the field by locksmiths could be achieved using existing pinning kits requiring only modified plugs that have been drilled to provide pin retaining means chambers.

It is another advantage of particular embodiments of the present invention that existing locks can be retro-fitted with a modified plug on site providing a system for economically upgrading existing locks to a higher level of security without having to replacing the entire existing locks.

It is also an advantage of particular embodiments of the present invention that the cylinder housing does not require modification so that any of the many varieties of housing available on the market can be used because modification is only required to the plug.

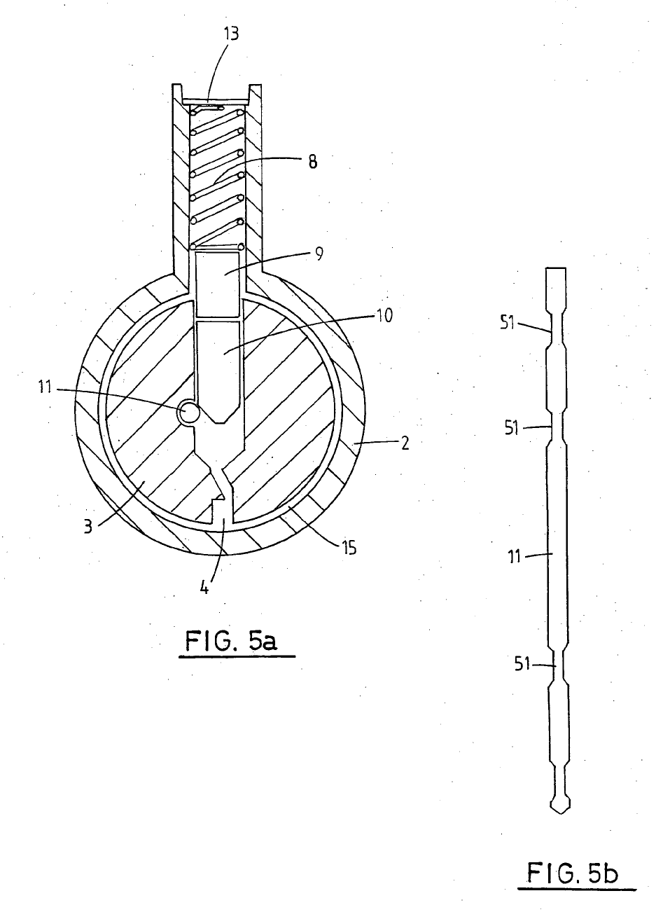

While particular pin retaining means have been described having particular preferred orientations, the invention is not limited thereto. For example, while the pin retaining means chambers have been shown in the preferred configuration as being orthogonal to the longitudinal axis of the plug for ease of manufacture/assembly, other orientations, including substantially parallel to said axis as shown in FIGS. 5a and 5b, will be readily apparent to the skilled person from the teaching herein and all such alternatives are included within the scope of the invention. Moreover, where a lock includes a plurality of top and bottom pin pairings, the pin retaining means may be configured to act on or engage any one or more, including all, of the bottom pins.

Referring to FIGS. 5a and 5b, there is shown a lock according to an embodiment of the invention in which the pin retaining means 11 is substantially parallel to the axis of the barrel. Pin retaining means 11 includes notches 51 (see FIG. 5b), each of which corresponds in position to a bottom pin. Where notches 51 are provided, the bottom pins are free to move in the pin chambers and are prone to bumping. Where notches are not provided, movement of the corresponding bottom pin is limited, increasing resistance to bumping.

Wherein the foregoing description reference has been made to integers or components having known equivalents thereof, those integers are herein incorporated as if individually set forth.

While the invention has been described with reference to specific examples and embodiments thereof, it is to, be appreciated that modifications may be made to the embodiments without departing from the spirit or scope of the invention.

1. A bump resistant pin-tumbler lock including:
a housing;
a plug rotatably mounted within the housing and having a keyway extending substantially along the longitudinal axis thereof, the keyway being shaped and dimensioned to receive a key for the lock; and
a shear line defined between the interface of the plug and housing;
wherein the plug has one or more pin chambers extending substantially from and substantially orthogonally to the shear line and the keyway, each pin chamber being capable of housing a bottom pin, and each pin chamber being aligned with a corresponding driver chamber when the plug is in a locked position; each driver chamber extends into the housing substantially from and substantially orthogonally to the shear line and each driver chamber further includes a biasing means and is adapted to housing one or more top pins; the plug further includes a bottom pin retaining means extending into one of the pin chambers so as to selectively retain a predetermined bottom pin in its respective pin chamber and prevent the predetermined bottom pin from fully extending into the normal resting position thereof, such that, in use, kinetic energy cannot be transferred to the predetermined bottom pin from a bump member that is cut to the full depth in all positions; and said pin retaining means is shaped and dimensioned so that it does not interfere with the actuation of the lock by the key.

2. (canceled)

3. The bump resistant pin-tumbler lock as claimed in claim 1 wherein the pin retaining means is adapted and dimensioned so that the predetermined bottom pin rests on the pin retaining means.

4. The bump resistant pin-tumbler lock as claimed in claim 1 wherein the pin retaining means extends from the external surface of the plug adjacent the shear line into the part of the chamber that is not in the keyway.

5. The bump resistant pin-tumbler lock as claimed in claim 1 wherein the plug includes one or more pin retaining means chambers, the or each said pin retaining means chamber being configured to receive the pin retaining means.

6. The bump resistant pin-tumbler lock as claimed in claim 5 wherein the one or more pin retaining means chambers have been drilled in the plug.

7. The bump resistant pin-tumbler lock as claimed in claim 5 wherein the or each pin retaining means chamber extends towards the keyway substantially orthogonal to a respective pin chamber.

8. The bump resistant pin-tumbler lock as claimed in claim 5 wherein the pin retaining means is removable from the one or more pin retaining means chambers.

9. The bump resistant pin-tumbler lock as claimed in claim 1 wherein the pin retaining means acts to change the resting position of a bottom pin so that a bump key will not work unless it has been cut to match the altered resting heights.

10. The bump resistant pin-tumbler lock as claimed in claim 1 wherein the pin retaining means is a tapered pin.

11. (canceled)

12. (canceled)

13. The bump resistant pin-tumbler lock as claimed in claim 1 wherein the pin retaining means is made of one or more of brass, plastic, steel, hardened steel or zinc.

14. A plug for use in a bump-resistant pin tumbler lock, the plug including:
a keyway extending substantially along the longitudinal axis of the plug, and being shaped and dimensioned to receive a key for the lock;
one or more pin chambers extending substantially from the keyway, each pin chamber being capable of housing a bottom pin;
at least one bottom pin retaining means chamber, extending into at least one of the pin chambers substantially orthogonally to a respective one of the one or more pin chambers, wherein each said at least one bottom pin retaining means chamber is configured to receive a bottom pin retaining means in use so as to selectively retain a bottom pin in its respective pin chamber and prevent the bottom pin from fully extending into the pin chambers, such that, in use, kinetic energy cannot be transferred to the retained bottom pin from a bump member cut to the normal full depths; and
wherein said bottom pin retaining means and/or the respective bottom pin retaining means chamber is shaped and dimensioned so that the bottom pin retaining means does not interfere with the actuation of the lock by the key.

15. (canceled)

16. The plug as claimed in claim 14 wherein the or each bottom pin retaining means chamber is adapted and dimensioned so that, in use, the bottom pin rests on the respective pin retaining means.

17. The plug as claimed in claim 16 wherein the one or more pin retaining means chambers are formed by holes drilled in the plug.

18. The plug as claimed in claim 16 including said pin retaining means inserted into one or more of said pin retaining means chambers.

19. A method of manufacturing a bump-resistant lock or a plug for a bump-resistant lock, the method including forming at least one pin retaining means chamber in the plug, wherein in use the at least one pin retaining means chamber is capable of housing a pin retaining means.

20. The method of manufacturing as claimed in claim 19 including positioning a pin retaining means in the or at least one of the pin retaining means chambers.

21. A method of retrofitting a pin-tumbler lock, the method including forming at least one pin retaining means chamber in the plug of the lock, wherein in use the at least one pin retaining means chamber is capable of housing a pin retaining means.

22. The method of retrofitting as claimed in claim 21 wherein the method includes positioning pin retaining means in the or at least one of the pin retaining means chambers.

23. (canceled)
